(19) United States
(12) Patent Application Publication
(10) Pub. No.: US 2012/0116722 A1
(43) Pub. Date: May 10, 2012

(54) Detection of Defects in an Electrochemical Device

(75) Inventors: Nadia Yousfi-Steiner, Belfort (FR); Philippe Mocoteguy, Niederlaurterbach (FR); Ludmila Gautier, Roeschwoog (FR); Daniel Hissel, Ronchamp (FR); Denis Candusso, Belfort (FR)

(73) Assignees: ELECTRICITE DE FRANCE, Paris (FR); UNIVERSITE DE FRANCHE-COMTE, Besancon (FR); INRETS, Bron (FR)

(21) Appl. No.: 13/380,673

(22) PCT Filed: Jun. 24, 2010
(86) PCT No.: PCT/FR10/51295

§ 371 Date: Dec. 23, 2011

(30) Foreign Application Priority Data
Jun. 25, 2009 (FR) 09 54357

(51) Int. Cl. G06F 15/00

(52) U.S. Cl. 702/185; 702/183

(57) ABSTRACT

A method for detecting defects in an electrochemical device, including obtaining at least one characteristic value dependent on at least one variable received from the electrochemical device and determining at least one defect in said device from the characteristic value obtained. The method comprises a mathematical operation including a wavelet transform, which operation is carried out in order to obtain the characteristic value from the variable received. The invention also relates to a device that carries out one such method, as well as to a corresponding computer program.

This invention relates to the field of detecting defects in electrochemical devices.

Currently there are various devices known as “electrochemical” devices, meaning they rely on the conversion of chemical energy into electrical energy or vice versa.

A first category of this type of device concerns devices which convert chemical energy into electrical energy in order to supply this energy to electrical devices or store it for later use. Examples of such devices are batteries, fuel cells, or supercapacitors.

A second category of this type of device concerns devices which use various methods relying on electricity to perform chemical reactions, or to separate products or reagents. Such devices commonly use “electrochemical” methods such as electrodeposition, electrical discharge machining, or electroflotation.

The reliability and service life of these electrochemical devices are limited by various phenomena. For devices which convert chemical energy into electrical energy, such as fuel cells, two main phenomena lead to a decrease in performance or even to complete failure of the device.

The service life of these devices is reduced by cycles of charging/discharging or by intermittent operation with accumulated shutdowns and powerups or variations in power demand.

In addition, certain incidents such as failures in controlling certain parameters of the electrochemical method used (interruption in the reagent supply, poor management of reaction products and sub-products), poisoning of the medium, or failure of a component or a module for example, can occur during their operation.

These harmful phenomena require the use of diagnostic methods for detecting them and possibly correcting them.

In a conventional electrochemical device, the conventional diagnostic methods are usually based on knowledge of certain parameters, which may be external or internal to these systems, requiring specific instrumentation such as internal sensors inserted into the electrochemical device itself.

Such instrumentation is not always desirable, because it is often costly and difficult to implement due to the geometry of the electrochemical system, which is rarely suitable for installing sensors, particularly those internal to the device.

In addition, because of their insertion, such internal sensors alter the device which can increase the probability of defects and lead to incorrect diagnoses. Also, when using an electrochemical system for mobile applications, the size of the device must be as small as possible and therefore so must be the diagnostic instrumentation, which rules out the use of conventional methods.

In the particular but not exclusive case of proton exchange membrane fuel cells (PEMFC), studies have been conducted in order to understand the degradation mechanisms and improve reliability and service life. Certain physical models have been developed. However, they require a certain number of parameters which are difficult or even impossible to measure in order to use them. In addition, their complexity generally requires significant calculation time which makes it difficult to apply them in real time diagnosis.

The invention aims to overcome these disadvantages.

An object of the invention is therefore to provide a method for detecting a defect in an electrochemical device, in a non-intrusive manner.

Another object of the invention is to provide a method for detecting defects using minimal instrumentation.

Yet another object of the invention is to provide a generic method for detecting defects in an electrochemical device which can be used for different systems independently of their types, geometries, sizes, or applications.

Lastly, another object of the invention is to provide a method for detecting defects which is usable in real time.

For this purpose, the invention proposes a method for detecting a defect in an electrochemical device, comprising a step of obtaining at least one characteristic value from at least one variable received from said electrochemical device, and a step of determining at least one defect of said electrochemical device based on this obtained value, a mathematical operation comprising a wavelet transform being performed in order to obtain the characteristic value from the variable received.

Advantageously, the wavelet transform is a discrete wavelet transform in which the characteristic value obtained comprises at least one wavelet coefficient S_{a,b} dependent on a scale variable a and a translation variable b. This discretization improves the calculation time required for the decomposition into wavelets.

In particular, a plurality of characteristic values is obtained by the decomposition of a set of wavelet coefficients w_{j,p}, for which the scale-level variable j is less than a, into a plurality of sets of wavelet coefficients w_{j+1,p.}

Preferably, the scale variable of value a satisfies a=a₀^{j}, where j is a scale level and a₀ is a scale parameter, and a sets of characteristic values are obtained by the successive decomposition, for each value j from 0 to a given decomposition level, of each set of wavelet coefficients w_{j,p} into a₀ sets of wavelet coefficients w_{j+1,p}. This yields a high level of detail during the wavelet decomposition.

Preferably, the given decomposition level corresponds to a maximum decomposition level, so that a maximum level of detail is obtained during the wavelet decomposition.

In a preferred embodiment, the determination step comprises a step of comparing the characteristic value to at least one determination element separating at least one first defect class from a second defect class. Advantageously, the determination element is defined by means of a prior classification of a plurality of characteristic values into a plurality of defect classes.

Preferably, between obtaining the plurality of characteristic values and determining the defect, there is a step of selecting at least one relevant value (Valᵢ′) from among the plurality of characteristic values obtained, and the defect determination is made from said relevant value. This accelerates the calculation time.

It is particularly advantageous if the method comprises a preliminary processing step for the variable received from the electrochemical device. In particular, this preliminary processing step comprises a step of eliminating at least one frequency component of the variable received from the electrochemical device in order to optimize the calculation time required.

The invention additionally proposes a computer program containing instructions for implementing the steps of the above method.

The invention also proposes a device for detecting defects of an electrochemical device, comprising a processing module adapted to receive at least one variable from this electrochemical device and to generate at least one characteristic value from this variable by performing a mathematical operation comprising a wavelet transform, as well as a determination module adapted to determine at least one defect of the electrochemical device from at least one value received from the processing module.

The method, the computer program, and the defect detection device which are objects of the invention, will be better understood by reading the following description and examining the accompanying drawings, in which:

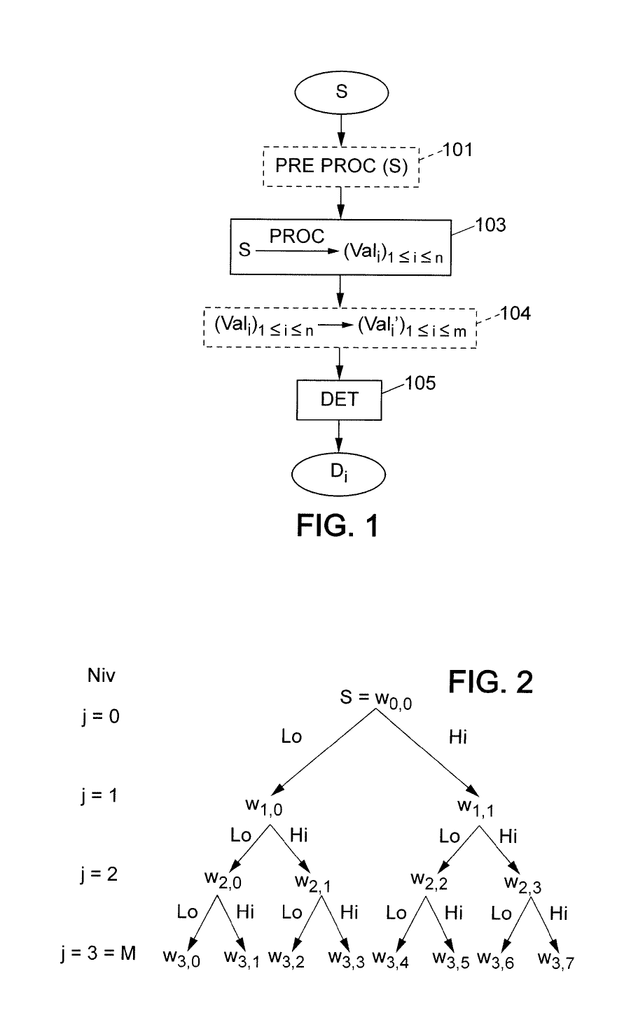

FIG. 1 illustrates the steps of a method for detecting a defect in an electrochemical device, according to the invention;

FIG. 2 illustrates a first type of tree structure, a complete tree, resulting from the use of a discrete wavelet transform;

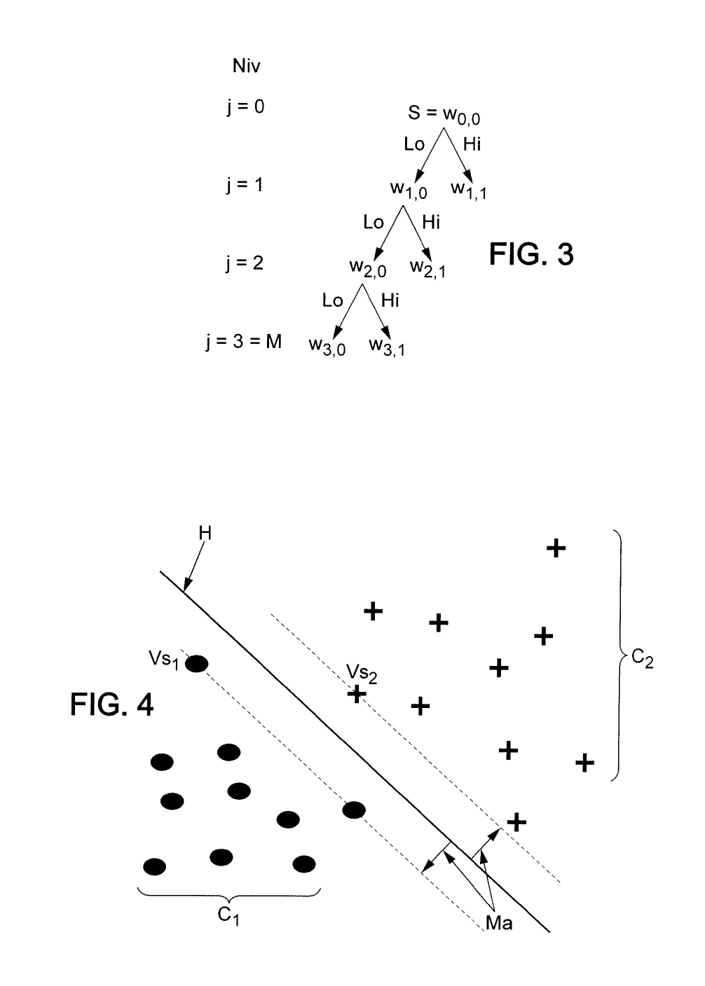

FIG. 3 illustrates a second type of tree structure, a partial tree, resulting from the use of a discrete wavelet transform;

FIG. 4 illustrates the concepts of margin, support vectors, and separating hyperplane as defined in a prior classification method;

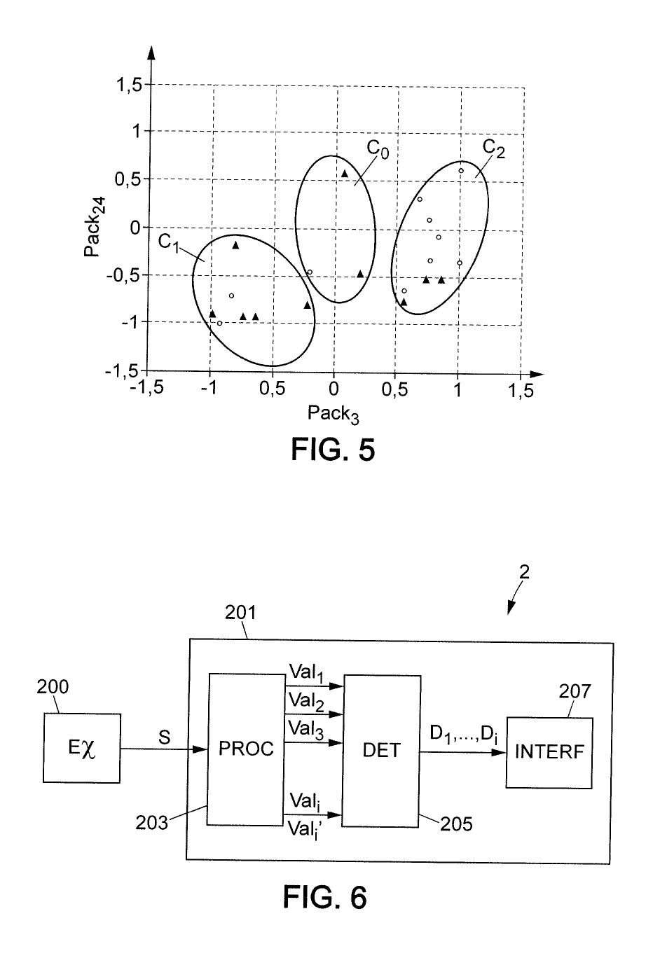

FIG. 5 illustrates an example of prior defect classification according to the invention, in the particular example of a fuel cell; and

FIG. 6 schematically represents a defect detection device in a electrochemical device, according to the invention.

First we will refer to FIG. 1, which illustrates the steps of a method for detecting defects in an electrochemical device of the invention.

Recall that the term “electrochemical device” as used here covers any device able to generate electrical energy by the conversion of chemical energy, and to supply it (either directly or by temporarily storing it), as well as any device able to use the conversion of electrical energy into chemical energy, for example in order to achieve chemical reactions or to separate products or reagents.

Such a device can consist of a battery, a fuel cell, or a supercapacitor. Or such a device can consist of an electrolyzer such as a cell for electroplating, for electrical discharge machining, for electrosynthesis, for electropurification, for electroconcentration, or for electroflotation. Such a device can also consist of an electrodialyzer.

In order to detect a possible defect in an electrochemical device, the method of the invention will comprise a certain number of successive operations performed on a variable S received from the electrochemical device, which allows conducting a non-intrusive diagnosis without requiring the insertion of sensors inside the source.

The variable S received from the source can consist of a signal of any type which allows characterizing the electrochemical device.

In the case of a device which generates electricity, this variable S can simply be any signal, such as voltage, current, or power, delivered as output from the device.

In the case of a device using electricity to perform a chemical conversion, this variable S can be the response of the device to a specified parameter which is input to such a device. If for example a specified current is input, the variable S can be the voltage response of this device. Conversely, if a specified voltage is input, the variable can be the current response of this device. Lastly, if a specified power is input, the variable can be the current response or voltage response of the device.

In the non-limiting example detailed below, this variable S is the output voltage measured at the terminals of a battery operating at a specified current, but one can easily consider using the current from a battery for which the voltage or power is specified, the power from a battery for which the voltage or current is specified, or, for any mode of operation, the pressures or concentrations of products or reagents, the flow rates of reagents or products, the temperature or any temporal or spatial variation in these variables.

During a first main step 103, a first treatment will be applied to the variable S received from the electrochemical device to be diagnosed, in order to obtain one or more values Valᵢ, where 1≦i≦n, which characterize one or more defect(s) of the electrochemical device.

In particular, if the variable S is analog in nature, the characteristic values Valᵢ obtained will be digital variables which can be used in subsequent digital processing.

From these obtained characteristic values Valᵢ, one or more defect(s) of the electrochemical device can then be determined during a second main step 105.

The step 105 can be unsupervised, where the characteristics Valᵢ are divided into more or less organized structures by grouping them according to a defined criterion, or supervised based on a set of already classified data.

To do this in the supervised case for example, the obtained characteristic values Valᵢ are compared with a series of previously classified values which are each associated with a particular state of the electrochemical device, for example a state in which a particular type of defect is present. From this comparison at least one possible defect Dᵢ of the electrochemical device can be deduced.

The method of the invention is therefore first characterized by the use of a mathematical operation comprising a wavelet transform during the first main step 103, in order to obtain the values Valᵢ from the variable S received.

A wavelet is a mathematical function ψ localized around a central time and of limited duration. Its name (wavelet) reflects its compact and oscillating nature. Any mathematical function can be considered a wavelet if it has the properties of being oscillating, of finite energy, and having a mean equal to zero.

A first advantage of wavelet analysis over other methods of analyzing a variable is that there are many functions usable as the “mother wavelet.”

A function frequently used as the mother wavelet is the Mexican hat function. Its mathematical expression is as follows:

$$ψ ( t ) = ( 1 - {t}^{2} ) {e}^{- \frac{{t}^{2}}{2}} \qquad ( 1 )$$

From this mother wavelet, a family of wavelets (ψ_{a,b}(t))_{a,b} is defined by temporal translation and by dilatation (or wavelet compression) according to the following formula:

$${ψ}_{a , b} = \frac{1}{\sqrt{a}} ψ ( \frac{t - b}{a} ) \qquad ( 2 )$$

It is this family of wavelets, serving as a basis for the decomposition, which allows analyzing a given variable S. The variable b, called the “translation variable,” is a time localization parameter, while the variable a, called the “scale variable,” corresponds to a scale factor. Large scales correspond to an overall view of the signal, and small scales correspond to a description of the details. With the use of the wavelet transform, a variable can be analyzed at all scales, yielding a multiresolution analysis.

One can therefore obtain information on different phenomena (and therefore defects) occurring at different scales contained in this signal. At each level of decomposition, a signal is obtained at a different scale, which allows localizing the phenomena when advancing from one scale of decomposition to the next (more detailed) one.

To perform a wavelet transform, for each scale variable a, the wavelet is shifted from the origin of the time axis by the variable to be analyzed (by varying the translation variable b) in order to calculate a series of correlations between the two.

The results of these correlations correspond to a set of “wavelet coefficients,” S_{a,b}, which are largest when the form of the wavelet approaches that of the variable to be analyzed, and which satisfy the following equation:

$${S}_{a , b} = {\int }_{R} S ( t ) {ψ}_{a , b}^{*} ( t ) d t \qquad ( 3 )$$

where * indicates the conjugate and R the set of real numbers. The variable S is then described by these coefficients S_{a,b}, which can then serve as characteristic values Valᵢ for determining a defect of the device.

This is called a continuous wavelet transform (CWT) of a variable S when the variables a and b are varied continuously. Such a continuous wavelet transform provides a complete description of the signal S(g), but the cost is the difficulty of implementing the equation (2) and the high redundancy that results.

To overcome this difficulty, it is advantageous to use a type of wavelet transform called a discrete wavelet transform, which is limited to using a few discrete values for the variables a and b. For many applications, values of a and b are chosen as defined by:

a=a₀^{j} where a₀>1 (4)

b=k.b₀.a₀^{j}, where b₀>0 and j and k are integers (5)

The variables j and k are respectively the scale and translation levels. The result obtained is a series of discrete values: this is called wavelet series decomposition. Purely for illustrative purposes, the values chosen here are b₀=1 and a₀=2, corresponding to a dyadic decomposition in which the scale variable assumes the successive values 1,2,4,8, etc.

In this particular case, the wavelets used to decompose the signal satisfy the equation:

$${ψ}_{j , k} ( t ) = \frac{1}{\sqrt{{2}^{j}}} ψ ( \frac{t - {2}^{j} k}{{2}^{j}} ) , ( j , k ) ∈ {Z}^{2} \qquad ( 6 )$$

and the wavelet coefficients are defined by:

$${S}_{j , k} = {\int }_{R} S ( t ) {ψ}_{j , k}^{*} ( t ) d t \qquad ( 7 )$$

and the original variable S is defined on the basis of corresponding wavelets according to:

$$S ( t ) = {\sum }_{j ∈ Z} {\sum }_{k ∈ Z} {S}_{j , k} {ψ}_{j , k} ( t ) \qquad ( 8 )$$

From the simple point of view of signal processing, only two types of elements are to be considered: the variable to be analyzed and the function which analyzes it or filters it. From this point of view, the discrete wavelet transform of a signal can be viewed as passing this signal through a filter bank.

At a given scale, the discrete wavelet transform consists of passing the coefficients from a previous scale through a bank consisting of a₀ filters. In an example where the factor a₀ is equal to 2, a low-pass filter gives a rough image of the signal and a high-pass filter gives the details. These two filters are complementary: the frequencies eliminated by one are recovered by the other. The iterative use of filter banks results in the tree structures illustrated in FIGS. 2 and 3.

At each scale level j, sets w_{j,p} of coefficients are obtained in which the parameter p indicates the position in the tree and varies between 0 and 2^{j}−1, and is equal, for each node corresponding to a set of coefficients w_{j,p}, to the number of nodes to its left. It can be considered as a frequency index. The set w_{j,p} comprises a sequence of coefficients S_{j,k}, where k varies from 0 to 2^{M-j}−1, in which this parameter M corresponds to a maximum level of decomposition of the signal to be decomposed, which can correspond, for example in the case where the length of this signal is an integer power of 2, to the natural logarithm of the length of this signal.

For a fixed scale level j, the set w_{j,p} of coefficients therefore satisfies:

w_{j,p}={S_{j,k}, k=0, . . . ,2^{m-j}−1} (9)

FIG. 2 illustrates a variable S to which three successive levels of filtering are applied. At each scale level j, from 0 to a maximum decomposition level M, a succession of sets of coefficients w_{j,p} are obtained, corresponding to the application of low-pass filters (symbolized by “Lo”) and high-pass filters (symbolized by “Hi”) to each of the sets of coefficients w_{j-1,p} of the previous scale level j−1.

Such a transform, known as a wavelet packet transform, is complete in the sense that it allows completely characterizing the variable S at each complete decomposition level. At level j, 2^{j} sets of coefficients (or nodes) are obtained. Since the signal is completely represented at each decomposition level, this representation of the variable S by means of a complete “tree” having several levels is redundant. With such a tree structure, it is possible to select only the “significant” packets of a given defect and use only these packets to identify the defect.

FIG. 3 illustrates another example, showing a partial tree with three successive levels of filtering. In this specific case, the high-pass and low-pass filters are applied only to the set of coefficients w_{j,p} having a “tree position” variable p of zero (representing the “low frequency” components of the variable S), which in this case are the sets w_{0,0}, w_{1,0} and w_{2,0}, respectively corresponding to the scales a=0, a=2 and a=4.

In this case, the decomposition is limited to the sets of coefficients w_{j,0} for any j. The “high frequency” components of the variable S are no longer decomposed and are therefore analyzed in less detail than the low frequency ones.

Such a decomposition, where the coefficients to be obtained are selected, is less complete than the decomposition in FIG. 2 but can be useful when the range the variable S is to be decomposed into in order to determine a defect is known in advance. In this case, this decomposition is faster, more efficient in terms of calculation time, and directly focuses on a specific type of defect.

More generally, the coefficients obtained after the decomposition into wavelets or wavelet packets allow making use of the frequency content of these signals. Any change in the decomposed signal related to a given defect will be seen in one or more decomposition levels for a discrete wavelet transform or in one or more packets for a wavelet packet decomposition.

Such a decomposition allows characterizing one or more characteristics using the different sets of coefficients w_{j,p} obtained, such as the energy, the entropy, the mean, the maximum, the minimum, the standard deviation, the number of events satisfying a criterion, etc. These characteristics (similarly to the sets of coefficients w_{j,p}) can then correspond to the characteristic values Valᵢ which will be used to determine a possible defect during the second main step 105.

To do this, the obtained values Valᵢ are compared with a series of previously classified values and each one is associated with a particular state of the electrochemical device, for example a normal state D₀ or a state Dᵢ corresponding to a certain type of defect. A possible defect of the electrochemical device can be deduced from this comparison.

The values used for the prior classification are values similar in nature to the characteristic values obtained in step 103, which are classified into one or more defect classes C₁, C₂ each corresponding to a specific type of defect. This association of a value with a defect can be done using data from the manufacturer of the device to be analyzed or by training and feedback.

Prior classification of values into defect classes will allow defining one or more determining elements for the class separation. The obtained characteristic values Valᵢ are compared with these determining elements in step 105 to determine whether the value Valᵢ belongs to a defect class.

The form of such determining elements depends on the number of dimensions considered. If the prior classification is done in relation to a single determination axis, these determining elements will be threshold values to which the values Valᵢ will be compared.

In a two-dimensional classification where the correlation between two values Valᵢ is observed, the determining elements will be straight lines for example. Generally, the determining element will be a separating surface in a space of dimension N, for example a separating hyperplane in the linear case.

The prior classification of values can be done using various methods. One particularly advantageous method consists of using support vector machines.

Support vector machines (or SVM) are discrimination techniques based on supervised learning.

These support vector machines have the advantage of being able to work with high-dimensional data, of having a solid theoretical foundation, and of providing good results in practice. In addition, regardless of the application model, the performance of support vector machines is similar to or better than that of other classification methods.

Support vector machines are based on the following two essential concepts:

1) The construction of an “optimal” border separating the classes, which allows maximizing the minimum distance to border of the training set. This is done by formulating the problem as a quadratic optimization problem in which known algorithms are applied.

2) Support vector machines transform the space representing the input data into a higher dimensional space, possibly of infinite dimensions, in order to be able to reduce cases in which the data are not linearly separable to a simpler case of linear separation in an appropriate space, using kernel functions.

This method initially allows classifying the variables into two classes. However, extensions exist for classification into a larger number of classes.

Let us consider the case of two classes “−1” and “+1” to be separated, and the following training set:

D={(xᵢ,yᵢ)εR^{N}×{−1,1} where i=1, . . . k} (10)

There are two cases for constructing the optimal hyperplane separating the data belonging to the two different classes: either the data are linearly separable or the data are not linearly separable.

In the first case, where the data are linearly separable, the optimal hyperplane H satisfies:

$$\{ \begin{matrix}h ( {x}_{i} ) = w \cdot {x}_{i} + b \geq 1 , & si & {y}_{i} = + 1 \\ h ( {x}_{i} ) = w \cdot {x}_{i} + b \leq - 1 , & si & {y}_{i} = - 1\end{matrix} \qquad ( 11 )$$

which can also be written as:

yᵢ.h(xᵢ)=yᵢ(w.xᵢ+b)≧1, for i=1, . . . k (12)

The distance from point x in the hyperplane is then given by the orthogonal projection of this point onto the hyperplane, according to the equation:

$$d ( x ) = \frac{\vert w \cdot x + b \vert}{‖ w ‖} \qquad ( 13 )$$

One can then define a margin Ma corresponding to the smallest distance between the observations in the two classes and the hyperplane:

$$Ma = {min}_{x , y = 1} \frac{\vert w \cdot x + b \vert}{‖ w ‖} - {max}_{x , y = - 1} \frac{\vert w \cdot x + b \vert}{‖ w ‖} = \frac{2}{‖ w ‖} \qquad ( 14 )$$

The optimal separating hyperplane H, meaning the decision boundary, is the one that maximizes this margin Ma, which is the same as maximizing the sum of the distances of the two classes relative to the hyperplane, and therefore minimizing ∥w∥ subject to the constraints of equation (7). However, it may be easier to minimize ∥w∥₂ than ∥w∥.

Thus the problem of minimization can be formulated as a problem of minimizing a quadratic function with the following linear constraints:

$$\{ \begin{matrix}min \frac{1}{2} {‖ w ‖}^{2} & \\ {y}_{i} ( w \cdot {x}_{i} + b ) \geq 1 , & ∀ i ∈ \{ 1 , … k \}\end{matrix} \qquad ( 15 )$$

FIG. 4 illustrates these concepts of margin, support vectors, and separating hyperplane H in a specific two-dimensional case.

In this figure, two groups of values are classified into two classes C₁ and C₂ which respectively represent a defect D₁ and a defect D₂. The separating hyperplane H representing the boundary between these two classes C₁ and C₂ is the one which minimizes the margin Ma defined relative to the respective limit values Vs₁ and Vs₂ for each class Cᵢ, called “support vectors.”

Once this separating hyperplane H is defined by prior training, the determination step 105 consists of positioning the obtained characteristic values relative to this separating hyperplane H, which allows classifying these values into one of the classes C₁ and C₂ and deducing the associated defect Dᵢ.

The resolution of the minimization problem stated in (15) is done using Lagrange multipliers, for example, for each constraint. In this case the following equation is obtained:

$$L ( w , b , α ) = \frac{1}{2} {‖ w ‖}^{2} - {\sum }_{p = 1}^{k} {α}_{p} \cdot ( {y}_{p} ( w \cdot {x}_{p} + b ) - 1 ) \qquad ( 16 )$$

The Lagrangian must be minimized relative to w and b, and maximized relative to α.

By canceling the partial derivatives of the Lagrangian under Kuhn-Tucker conditions, the following system is obtained:

$$\{ \begin{matrix}max {\sum }_{i} {α}_{i} - \frac{1}{2} {\sum }_{i , j} {α}_{i} {α}_{j} {y}_{i} {y}_{j} {x}_{i} {x}_{j} \\ {α}_{i} \geq 0 for any i \\ {\sum }_{i} {α}_{i} {y}_{i} = 0\end{matrix} \qquad ( 17 )$$

The optimal Lagrange multipliers are therefore αᵢ*. It is shown that if the αᵢ* are solutions of this system, one then has:

w*=Σαᵢ*yᵢxᵢ (18)

Only the αᵢ* corresponding to the closest points are non-zero (the support vectors Vsᵢ and Vs₂ in FIG. 4).

The separating hyperplane in the linear case is therefore obtained by replacing w with its optimal value w*. The following equation is then obtained:

$$h ( x ) = {\sum }_{i} {α}_{i}^{*} {y}_{i} {x}_{i} \cdot x + b \qquad ( 19 )$$

In the other case where the data are not linearly separable, the optimal hyperplane is the one which satisfies the following conditions:

1) the maximum distance between the properly classified vectors and the optimal hyperplane must be maximal,

2) the distance between the improperly classified vectors and the optimal hyperplane must be minimal.

More formally, a non-linear transformation φ is applied to the input vectors x. The resulting space is called the feature space. This space is searched for the hyperplane satisfying:

H:x→w.φ(x)+b (20)

where yᵢh(xᵢ)>0, for all points of the training set, meaning the separating hyperplane in the feature space.

Using the same procedure as in the above case of linear separation, the optimization problem can then be written as follows:

$$\{ \begin{matrix}max {\sum }_{i} {α}_{i} - \frac{1}{2} {\sum }_{i , j} {α}_{i} {α}_{j} {y}_{i} {y}_{j} ϕ ( {x}_{i} ) \cdot ϕ ( {x}_{j} ) \\ {α}_{i} \geq 0 for any i \\ {\sum }_{i} {α}_{i} {y}_{i} = 0\end{matrix} \qquad ( 21 )$$

By introducing a kernel function defined by K(xᵢ,xⱼ)=φ(xᵢ).φ(xⱼ), the separating hyperplane in the non-linear case therefore has the equation:

$$g ( x ) = {\sum }_{i} {α}_{i}^{*} {y}_{i} K ( {x}_{i} , x ) + b \qquad ( 22 )$$

The use of a kernel function places us in the previously described linear case. There are numerous kernel functions, such as linear, polynomial, Gaussian, and Laplacian kernels.

Other prior classification methods can be used, such as a method using neural networks or the k nearest neighbors.

In one advantageous embodiment, a first optional preliminary processing step 101 is performed before the first main step 103, in order to preprocess the variable S to optimize the characteristic detection method.

One example of preprocessing consists of eliminating components from the variable S which have non-significant frequencies, in the case where the primary step 103 uses a wavelet decomposition. This optimizes this decomposition because then only the significant components are decomposed.

To do this, a filter can be used that has a cutoff frequency acting as a threshold parameter. The value of the threshold is, for example, determined empirically from feedback, knowledge of the system, or the significant frequency band.

In a particularly advantageous embodiment, there is an optimization step 104 between the first main step 103 and the second main step 105 of the defect determination, in order to select certain optimal values Valᵢ from among those obtained during step 103.

In fact, the direct use of the values Valᵢ in the defect determination step can present problems when the set of characteristic values Valᵢ generated during step 103 is very large and contaminated with noise or undesirable components.

In addition, the characteristic values Valᵢ often contain redundant information, and therefore do not all require processing.

Also, in order to optimize the determination process in step 105, it is desirable to reduce the number of values Valᵢ to be processed during a selection step 104 as much as possible, in order to retain only the most relevant values Val′ᵢ, where 1≦i≦m with m<n, considered to be the best for the determination step 105. This contributes to improving the robustness of the diagnosis of the electrochemical device and reducing the calculation time.

To do this, one particular embodiment can use a method for selecting the best wavelet base. This method is based on using a criterion for selecting a base referred to as the “best base.”

This method comprises the following two steps:
Applying a chosen criterion to the sets of characteristic values Valᵢ obtained during the decomposition into wavelets in step 103.
Sorting the characteristics found during the previous step by increasing or decreasing order of importance, depending on the chosen criterion, in order to eliminate the characteristic values Valᵢ considered to be “not significant.”

The remaining characteristic values Valᵢ will then be usable during the determination step 105.

An example of an optimal base for the detection is a base which maximizes the separability between the different frequency and time information. An optimal base for the determination is a base which maximizes the separability, or in other words the discrimination, between the different defect classes.

In this context, several criteria can be defined.

1) In a first example, “cross entropy” is used, which consists of measuring the distance between the time-frequency energy distributions of two sequences x and y, according to the following equation:

$$ER ( x , y ) = {\sum }_{i} {p}_{i} log ( \frac{{p}_{i}}{{q}_{1}} ) où {p}_{i} = \frac{{\vert {x}_{i} \vert}^{2}}{‖ x ‖} et {q}_{i} = \frac{{\vert {y}_{i} \vert}^{2}}{‖ y ‖} \qquad ( 23 )$$

This value corresponds to the Kullback-Leibler divergence between the distributions xi and yi representing two different classes.

One can then define a criterion D(x,y) to be optimized, such that:

D(x,y)=ER(x,y)+ER(y,x). (24)

In this example, each class of the training set is first represented by a tree in which each node contains an average sequence of squares of coefficients for the elements of the class.

As the criterion defined above is binary, it is applied pairwise to all classes and the final criterion is the sum of the resulting binary criteria.

2) In a second example, in order to maximize the capacity of the coefficients or packets obtained during step 103 for separating the different classes during step 105, the criterion here is to maximize the “interclass inertia,” meaning the variance between the classes furthest apart from each other, while minimizing the “intraclass inertia,” meaning the variance of the classes as close to each other as possible. The criterion can therefore consists of the ratio of the intraclass inertia to the total inertia. One can also consider using the ratio of the intraclass inertia to the interclass inertia.

In an example where there are k classes C1, C2, . . . , Ck of defects and respective centroids g1, g2, . . . , gk respectively containing n1, n2, . . . , nk elements, the centroid of the total point cloud can be denoted g.

The interclass inertia is then defined by the following equation:

$${I}_{inter} = \frac{1}{n} {\sum }_{i = 1}^{k} {n}_{i} \cdot {d}^{2} ( {g}_{i} , g ) \qquad ( 25 )$$

where d is a defined distance, for example a Euclidian distance.

The intra-class inertia is defined by the following equation:

$${I}_{intra} = \frac{1}{n} {\sum }_{e ∈ {G}_{i}}^{k} {d}^{2} ( {g}_{i} , e ) \qquad ( 26 )$$

As for the total inertia, it is defined by the following equation:

Iₜₒₜₐₗ=Iᵢₙₜᵣₐ+Iᵢₙₜₑᵣ (27)

The final criterion R is therefore given, for example, by the following relation:

$$R = \frac{{I}_{intra}}{{I}_{intra} + {I}_{inter}} \qquad ( 28 )$$

The classes to be separated are defined beforehand. One can therefore either discriminate between all defect classes simultaneously, separate the classes two by two, or separate a given class from all the others.

In another particular embodiment, the reduction in dimensionality in step 194 uses a singular value decomposition.

Remember that decomposing a matrix M of m rows and n columns into singular values is the same as writing it in the form:

M=U×Σ×V (29)

where Σ is a diagonal matrix containing the singular values λ_{i,i=1, . . . m} of the matrix M, for example in decreasing order.

$$\sum = ( \begin{matrix}{λ}_{1} & & & & \\ & {λ}_{2} & & 0 & \\ & & ⋱ & & \\ & 0 & & ⋱ & \\ & & & & {λ}_{m}\end{matrix} ) \qquad ( 30 )$$

The two other matrices U and V contain the singular vectors (the right and left singular vectors) corresponding to the singular values λ=_{i,i=1, . . . m}.

The singular values are interpreted as reflecting the degree of inertia or representativity, and the singular vectors are the axes along which the variation in the initial data (matrix M) is the highest. When the singular values are ordered in decreasing order, the last values are those which contain the least variation in data. Thus the dimensionality reduction based on the change from m to p singular values (p<n) assumes that the information contained in the m−p+1 last singular values λᵢ is negligible.

Other methods for the dimensionality reduction can be considered, such as principal component analysis for example.

Next, FIG. 5 illustrates an example of defect classification according to the invention, in the non-limiting case of a fuel cell.

In this FIG. 5, a set of characteristic values are represented on a graph as a function of two distinct wavelet packets.

The position of these characteristic values is associated, by training, with specific operating states of the fuel cell to be diagnosed.

A first group of characteristic values, located at the center of the graph, defines a class C₀ of characteristic values corresponding to a normal operating state of the fuel cell.

A second group of characteristic values, located to the left in the graph, defines a class C₁ of characteristic values corresponding to an abnormal operating state where the fuel cell has a dryout defect.

Lastly, a third group of characteristic values, located to the right in the graph, defines a class C₂ of characteristic values corresponding to an abnormal operating state where the fuel cell has a flooding defect.

These classes C₀, C₁, C₂ are defined by training and by measuring characteristic values in cells having the various states in question. The boundaries of these class values, for example defined by determination elements calculated as above, are stored in the module 205 and associated with state variables D₀, D₁, D₂ respectively representative of a normal state, an abnormal state with a dryout defect, and an abnormal state with a flooding defect.

When a new diagnosis is conducted on a fuel cell of the same type as the one used in the supervised classification during training, the same wavelet packets are observed in order to position the characteristic value in one of the zones Z₀ to Z₂. A state variable D₀ to D₂ indicative of a particular state will be generated by the determination module 205 as a function of the zone in which the measured characteristic value is located.

Lastly, FIG. 6 shows a schematic representation of a device for detecting a defect in an electrochemical device of the invention.

In this figure, an electrochemical device 200, of any of the types indicated above, provides a variable S to the detection device 201.

This detection device 201 comprises a processing module 203 connected to a determination module 205, which itself is connected to an interface module 207.

The processing module 203 is adapted to perform the first main transformation step 103, as well as the possible optional steps 101 and 104 of preliminary processing and selection of relevant characteristic values Valᵢ′ as described above.

Such a processing module 203 can consist of a processor, a micro-processor, or any other component, for example on an integrated circuit, able to perform calculations using digital values or execute a computer program for this purpose.

When the variable S to be analyzed is analog in nature, the processing module 203 can comprise an analog-to-digital converter for converting the variable S into a digital value that can be processed.

The processing module 203, once it has carried out the main step 103 of obtaining one or more value(s) Valᵢ, provides said value(s) to the defect determination module 205. In the particular case where an optional selection step 104 is also performed by the processing module 203, it is the relevant characteristic values Valᵢ′ that are provided to the defect determination module 205.

In the example in FIG. 6, the values Valᵢ are shown as being provided by several parallel connections, but a single connection could be used, in which case these values are transmitted serially. The first parallel embodiment transfers the values more quickly, while the second serial embodiment simplifies and reduces the cost of the connection between the modules 203 and 205.

The determination module 205 is adapted to determine one or more characteristic(s) Dᵢ of the electrochemical device from the values Valᵢ received from the processing module 205. To achieve this, it may comprise a classification means in which the characteristics are classified as a function of these values.

Such a classification means may, for example, use a method based on a neural network, having been trained to classify the different defects on the basis of fuzzy logic or values received as input.

This classification means can also use statistical methods such as support vector machines, principal component analysis, or determining the k nearest neighbors.

In response to a certain number of values Valᵢ, the determination module 205 will therefore make use of its classification means to output one or more variables Dᵢ indicative of a characteristic of the electrochemical device, for example a characteristic of a normal state (for D₀) or of one or more defects.

These values Dᵢ are then received by an interface module 207 which will indicate the operating state of the electrochemical device, as a function of the variable(s) Dᵢ received, to the user of the detection device 201 or to a control system situated downstream from the detection device.

This can be done as a display (which can specify the type of the state or defect as a function of the variable Dᵢ), an audible alarm, or any other signal that informs the user or the regulation and control system located downstream of a normal or abnormal operating state of the electrochemical device to be diagnosed.

Of course, the invention is not limited to the specific details of the examples described and represented above, from which other embodiments can be devised without leaving the scope of the invention.

1. Defect detection method for detecting a defect in an electrochemical device, comprising the obtaining of at least one characteristic value from at least one variable received from said electrochemical device and the determination of at least one defect of said electrochemical device from said obtained value, wherein a mathematical operation comprising a wavelet transform is performed to obtain the characteristic value from the variable received.

2. Defect detection method according to claim 1, wherein said wavelet transform is a discrete wavelet transform in which the characteristic value obtained comprises at least one wavelet coefficient S_{a,b} dependent on a scale variable of value a and a translation variable of value b.

3. Defect detection method according to claim 2, wherein a plurality of characteristic values is obtained by the decomposition of a set of wavelet coefficients w_{j,p}, for which the scale-level variable j is less than a, into a plurality of sets of wavelet coefficients w_{j+1,p.}

4. Defect detection method according to claim 3, wherein the scale variable of value a satisfies a=a₀^{j}, where j is a scale level and a₀ is a scale parameter, and a sets of characteristic values are obtained by the successive decomposition, for each value j from 0 to a given decomposition level, of each set of wavelet coefficients w_{j,p} into a₀ sets of wavelet coefficients w_{j+1,p.}

5. Defect detection method according to claim 4, wherein the given decomposition level corresponds to a maximum decomposition level M.

6. Defect detection method according to claim 1, wherein the determination step comprises a step of comparing the characteristic value to at least one determination element separating at least one first defect class from a second defect class.

7. Defect detection method according to claim 6, wherein the determination element is defined by means of a prior classification of a plurality of characteristic values into a plurality of defect classes.

8. Defect detection method according to claim 1, wherein, between obtaining said plurality of characteristic values and determining the defect, there is a step of selecting at least one relevant value from among the plurality of characteristic values obtained, and the defect determination is made from said relevant value.

9. Defect detection method according to claim 1, comprising a preliminary processing step for the variable received from the electrochemical device.

10. Defect detection step according to claim 9, wherein the preliminary processing step comprises a step of eliminating at least one frequency component of the variable received from the electrochemical device.

11. Computer program, downloadable via a telecommunication network and/or stored in the memory of a computer and/or stored on a storage medium intended to cooperate with a reader of said computer, comprising instructions for implementing the steps of a defect detection method according to claim 1.

12. Defect detection device for an electrochemical device, comprising:
a processing module adapted to receive at least one variable from said electrochemical device and to generate at least one characteristic value from said variable by performing a mathematical operation comprising a wavelet transform, and
a determination module adapted to determine at least one defect of said electrochemical device from at least one value received from the processing module.

13. Defect detection device according to claim 12, wherein the determination module comprises a defect classification means adapted to provide a variable indicative of a defect in response to the characteristic value received from the processing module.

14. Defect detection device according to claim 13, wherein the defect classification means makes use of a neural network.

15. Defect detection device according to claim 12, wherein said wavelet transform comprises the decomposition of the variable into a plurality of wavelet coefficients, which is a discrete transform into wavelet coefficients S_{a,b} dependent on a scale variable of value a and a translation variable of value b.
